(19) United States
(12) Patent Application Publication
(10) Pub. No.: US 2025/0077872 A1
(43) Pub. Date: Mar. 6, 2025

(54) Systems and Methods for Efficient Trainable Template Optimization on Low Dimensional Manifolds for Use in Signal Detection

(71) Applicant: The Trustees of Columbia University in the City of New York, New York, NY (US)

(72) Inventors: Jingkai YAN, New York, NY (US); Shiyu Wang, New Yor, NY (US); Xinyu Rain Wei, New York, NY (US); Zsuzsanna Marka, New York, NY (US); Szabolcs Marka, New York, NY (US); John Wright, New York, NY (US)

(73) Assignee: The Trustees of Columbia University in the City of New York, New York, NY (US)

(21) Appl. No.: 18/820,857

(22) Filed: Aug. 30, 2024

Related U.S. Application Data
(60) Provisional application No. 63/536,234, filed on Sep. 1, 2023.

(51) Int. Cl. G06N 3/084

(52) U.S. Cl. CPC G06N 3/084

(57) ABSTRACT

Disclosed are systems, methods, computer program products, and other implementations, including a method for signal detection is disclosed that includes obtaining samples of observation data comprising a signal component produced by a source object, and a noise component, and generating based on at least one of the samples of the observation data, processed by a machine learning template derivation system, a filtering template to separate the signal component from the noise component, with the machine learning template derivation system including one or more trainable layers, and with at least one layer of the one or more trainable layers implementing a respective one of one or more iterations of an unrolled optimization process to determine optimized template parameters for the filtering template. The method further includes applying the filtering template to one or more of the samples of the observation data to obtain the signal component of the observation data.

### CROSS-REFERENCE TO RELATED APPLICATIONS

This application claims priority to, and the benefit of, U.S. Provisional Application No. 63/536,234, entitled “Systems and Methods for Efficient Trainable Template Optimization on Low Dimensional Manifolds for Use in Signal Detection” and filed Sep. 1, 2023, the content of which is incorporated herein by reference in its entirety.

### STATEMENT REGARDING FEDERALLY SPONSORED RESEARCH

This invention was made with government support under grant No. 2112085 awarded by the National Science Foundation (NSF). The government has certain rights in the invention.

### BACKGROUND

In numerous scenarios in science and engineering, the problem of detecting and recovering signals from noisy measurements poses a serious challenge. One factor that enables distinguishing signal from noise is that natural signals possess low-dimensional structures. That is, often the target signal lies on or near a low-dimensional submanifold of a very high-dimensional signal space. This general assumption arises naturally in scientific data analysis, imaging (medical, scientific, and natural images), neural data analysis (spike sorting), health monitoring (EKG), etc.

Appropriately leveraging low-dimensional structures in the set of target signals is critical for designing efficient detection process. Notably, however, a popular family of techniques exemplified by matched filtering (also known as template matching) makes inefficient use of such low-dimensional information in that such techniques compute the maximal correlation between the input and each template from a template bank. Under the matched filtering approach, a bank of templates is constructed, and different templates are individually evaluated relative to the observations. When the template bank covers the signal space sufficiently densely, at least one template will lie close to the true input signal, thus giving the result of detection.

Techniques such as matched filtering techniques suffer from the problem of dimensionality, and can make searching higher-dimensional signal spaces difficult or even intractable. For example, for gravitational wave detection, where matched filtering is the current method of choice, the burden of enormous template banks has posed challenges for searching over wider ranges of signals.

### SUMMARY

Described herein is a proposed scalable template optimization framework (referred to as TpopT) to detect low-dimensional families of signals, so as to maintain high interpretability. Low-dimensional structures are ubiquitous in data arising from physical systems: these systems often involve relatively few intrinsic degrees of freedom, leading to low-rank, sparse, or manifold structures. The proposed TpopT framework provides an approach for dealing with the fundamental problem of detecting and estimating signals, which belong to a low-dimensional manifold, from noisy observations. Characteristics of the proposed TpopT framework include convergence of Riemannian gradient descent, and superior dimension scaling to covering. Implementations of the proposed TpopT framework include a practical template optimization for nonparametric signal sets, which incorporates techniques of embedding and kernel interpolation, and is further configurable into a trainable network architecture by unrolled optimization. The proposed trainable TpopT framework exhibits significantly improved efficiency-accuracy tradeoffs, for example, for gravitational wave detection over, for example, matched filtering techniques.

In some variations, a method for signal detection is disclosed that includes obtaining samples of observation data comprising a signal component produced by a source object, and a noise component, and generating based on at least one of the samples of the observation data, processed by a machine learning template derivation system, a filtering template to separate the signal component from the noise component, with the machine learning template derivation system including one or more trainable layers, and with at least one layer of the one or more trainable layers implementing a respective one of one or more iterations of an unrolled optimization process to determine optimized template parameters for the filtering template. The method further includes applying the filtering template to one or more of the samples of the observation data to obtain the signal component of the observation data.

Embodiments of the method may include at least some of the features described in the present disclosure, including one or more of the following features.

The observation data may be representative of signals measured in a high-dimensional signal space, and the signal component produced by the source object may be a low-dimensional submanifold of the high-dimensional signal space.

The unrolled optimization process can include a gradient descent optimization process.

Generating the filtering template can include determining, in response to the at least one of the samples of the observation data, layer output parameters representing a resultant respective Jacobian matrix and step size information for a respective one of one or more iterations of the gradient descent optimization process implemented by the one or more layers of the machine learning template derivation system.

The resultant respective Jacobian matrix and step size for the respective one of the one or more iterations of the gradient descent optimization process may be represented by a collection of resultant layer output lookup matrices, W.

Determining the layer output parameters may include applying the trained parameter values of the at least one layer of the machine learning template derivation system to the at least one of the samples of the observation data, and further to a previously determined set of values of the template parameters, ξ^{k-1}, to generate the layer output parameters representing the resultant respective Jacobian matrix and the step size information for the respective one of the one or more iterations of the gradient descent optimization process.

The method can further include combining the layer output parameters with the previously determined set of values of the template parameters to produce a next set of values of template parameters, ξ^{k}.

The next set of values of the template parameters, ξ^{k}, can be produced by a last layer of the machine learning, with ξ^{k} representing the final template parameters for the filtering template.

The next set of values of template parameters, ξ^{k}, can be produced by a first layer of the machine learning template derivation system, with the previously determined set of values of the template parameters, ξ^{k-1} representing an initial estimate, ξ⁰, of the template parameters for the filtering template.

The method may further include providing the next set of values of template parameters, ξ^{k}, and the at least one of the samples of the observation data to a next at least one layer of the one or more layers of the machine learning template derivation system to determine a further next set of values of the template parameters, ξ^{k+1}.

The samples of observation data can include samples of gravitationally-produced observation data comprising a gravitational waves data component.

The machine learning template derivation system can include a neural-network-based machine learning template derivation system.

The method may further include training, prior to obtaining the samples of observation data, the one or more layers of the machine learning template derivation system with training data, the training data comprising input data representing observation samples, and output data representing ground truth data associated with the input data, with the ground truth data including one or more of, for example, template parameters computed in response to the training data using a matched filtering technique and/or previously determined template parameters that were used for the input data.

In some variations, a signal detection system is provided that includes one or more memory storage devices, and a processor-based device in electrical communication with the one or more memory storage devices. The processor-based device is configured to obtain samples of observation data comprising a signal component produced by a source object, and a noise component, and generate based on at least one of the samples of the observation data, processed by a machine learning template derivation system, a filtering template to separate the signal component from the noise component, with the machine learning template derivation system including one or more trainable layers, and with at least one layer of the one or more trainable layers implementing a respective one of one or more iterations of an unrolled optimization process to determine optimized template parameters for the filtering template. The processor-based device is further configured to apply the filtering template to one or more of the samples of the observation data to obtain the signal component of the observation data.

In some variations, a non-transitory computer readable media is provided that includes computer instructions executable on a processor-based device to obtain samples of observation data comprising a signal component produced by a source object, and a noise component, and generate based on at least one of the samples of the observation data, processed by a machine learning template derivation system, a filtering template to separate the signal component from the noise component, with the machine learning template derivation system including one or more trainable layers, and with at least one layer of the one or more trainable layers implementing a respective one of one or more iterations of an unrolled optimization process to determine optimized template parameters for the filtering template. The computer instructions include one or more further instructions to apply the filtering template to one or more of the samples of the observation data to obtain the signal component of the observation data.

Embodiments of the system and the computer readable media may include one or more of the features described in the present disclosure, including one or more of the features described above in relation to the method.

Other features and advantages of the invention are apparent from the following description, and from the claims.

### BRIEF DESCRIPTION OF THE DRAWINGS

These and other aspects will now be described in detail with reference to the following drawings.

FIG. 1 includes diagrams illustrating smoothed optimization landscapes for different levels of smoothing.

FIG. 2A is a diagram of a system architecture for an example implementation of a trainable TpopT framework.

FIG. 2B is a block diagram of a system architecture for another example implementation of a trainable TpopT framework.

FIG. 3 is a flowchart of an example procedure for signal detection using an optimized noise filtering template applied to high-dimensional data.

FIG. 4 includes a graph of an example gravitational wave signal, and a heatmap diagram of an optimization landscape in physical parameter space (mass-spin-z) for gravitational waves.

FIG. 5 includes a graph of classification scores for MF and TpopT approaches at different complexity levels for gravitational wave detection.

FIG. 6 includes a graph showing a slice of a 3D embedding projected onto the first two embedding dimensions, and a graph of classification scores for MF and TpopT approaches at different complexity levels for handwritten digit recognition.

Like reference symbols in the various drawings indicate like elements.

### DESCRIPTION

The present disclosure is directed to implementations of an efficient signal detection framework that derives optimal or near optimal matching templates that can be applied to noisy observation data to separate the desired signal component (produced by a physical system) from noise. The proposed framework implements, in some embodiments, a trainable unrolled optimization process, such as a gradient descent optimization process, as an alternative paradigm to the conventional approach of a covering-based search. The description provided herein focuses on gradient descent optimization processes, but the implementations may use other types of unrolled optimization processes, or other type of optimization processes that can be implemented using machine learning systems. An unrolled optimization process, used with the TpopT framework, includes two principal stages:
Formulating the search for the best-matching template as an optimization problem on the signal space, and obtaining a solver using a gradient descent optimization process (or some other unrolled optimization process); and
Reformulating the gradient descent solver to make its components (e.g., gradients and step sizes) trainable, to obtain a trainable network where each layer corresponds to one iteration of the gradient descent.

The proposed framework is motivated by a simple observation: instead of using sample templates to cover the search space, the search for a best-matching template can alternatively be performed via optimization over the search space with higher efficiency. In other words, while matched filtering (MF) searches for the best-matching template by enumeration, a first-order optimization method can take advantage of the geometric properties of the signal set, and avoid the majority of unnecessary templates. This approach is referred to as template optimization (TpopT). In many practical scenarios, an analytical characterization of the signal manifold is lacking. A nonparametric extension of TpopT is therefore proposed based on signal embedding and kernel interpolation. In contrast to conventional manifold learning, where the goal is to learn a representation of the data manifold, the goal under the proposed approaches is to learn an optimization process on the signal manifold. Components of this framework can be trained on sample data, reducing the need for parameter tuning and improving the performance in the presence of Gaussian noise.

The present framework thus applies an unrolled optimization approach to signal detection on general low-dimensional manifolds. Once trained with a one-time cost, the proposed model achieves efficient detection at deployment time. Experimentation and evaluations of implementations of the proposed framework show that those implementation can achieve a significant efficiency advantage over, for example, covering-based implementations, with an efficiency gain that is exponential in the signal manifold dimension.

The proposed framework has extremely wide applicability. For example, for the task of gravitational wave detection, a significant increase in detection accuracy was demonstrated at equal complexity. Theoretical analysis of the proposed framework suggests that even more significant improvements can be expected in broader signal spaces (i.e., an exponential dimension scaling advantage). The proposed framework thus has the potential to deliver expanded detection ranges, such as over eccentric gravitational wave signals with a much higher-dimensional parameter space.

Moreover, the proposed framework can be applied to any problem where a template bank is used for signal processing, such as the processing of sensor data or images, including EKG data analysis for health monitoring, neural spike sorting and medical and scientific imaging. By optimizing over the templates and further training them, a guaranteed improvement in the model efficiency can be obtained.

Before describing implementations of the proposed TpopT framework, the underlying problems and objectives motivating the TpopT approach will be discussed. As noted, the implementations described herein seek to detect and recover signals from low-dimensional physical systems. Assume that the signals of interest form a d-dimensional manifold S⊂R^{D}, where d«D, and that they are normalized such that S⊂S^{D-1}. For a given observation x∈R^{D}, a determination needs to be made of whether x includes of a noisy copy of some signal of interest, and if so, the signal needs to be recovered. More formally, the observation (x, y)∈R^{D}×{0, 1} is modelled as:

$$x = \{ \begin{matrix}{as}_{♮} + z & if y = 1 \\ z & if y = 0\end{matrix} .$$

where α∈ [symbol] ₊ is the signal amplitude, _{s♮}∈S is the ground truth signal, and z˜N(0, σ²I). The goal is to solve this detection and estimation problem with simultaneously high statistical accuracy and computational efficiency.

Under the matched filtering approach, a natural decision statistic for this detection problem is max_{s∈S} [symbol] s, x [symbol] , i.e.:

$$\hat{y} ( x ) = 1 ⇔ \begin{matrix}max \\ s ∈ S\end{matrix} 〈 s , x 〉 \geq τ$$

where τ is some threshold, and the recovered signal can be obtained as arg max_{s∈S} [symbol] s, x [symbol] . Matched filtering, or template matching, approximates the above decision statistic with the maximum over a finite bank of templates s₁, . . . , sₙ templates, as follows:

$${\hat{y}}_{MF} ( x ) = 1 ⇔ i = 1 , … {\begin{matrix}max \\ n\end{matrix}}_{templates} 〈 {s}_{i} , x 〉 \geq τ .$$

The template sᵢ contributing to the highest correlation is thus the recovered signal. This matched filtering method is a fundamental technique in signal detection (simultaneously obtaining the estimated signals), playing an especially significant role in scientific applications. If the template bank densely covers S, ŷ_{MF}(x) will accurately approximate ŷ. However, dense covering is inefficient as the number n of templates required to cover S up to some target radius r grows as n∝1/r^{d}, making this approach impractical for all but the smallest values of d.

In contrast, in the proposed template optimization procedure, rather than densely covering the signal space, template optimization (TpopT) searches for a best matching template, ŝ, by numerically solving

$$\hat{s} ( x ) = arg {min}_{s ∈ S} f ( s ) = - 〈 s , x 〉 .$$

The decision statistic is then ŷ_{TpopT}(x)=1⇔ [symbol] ŝ(x), x [symbol] ≥τ. Since the domain of optimization S is a Riemannian manifold, in principle, the optimization problem can be solved by the Riemannian gradient iteration, namely:

$${s}^{K + 1} = {exp}_{{s}^{k}} ( - {τ}_{k} grad [ f ] ( {s}^{k} ) ) . \qquad ( 1 )$$

Here, k is the iteration index, expₛ(v) is the exponential map at point s, grad [f](s) is the Riemannian gradient (the Riemannian gradient is the projection of the Euclidean gradient ∇ₛf onto the tangent space TₛS) of the objective f at point s, and τₖ is the step size.

Alternatively, if the signal manifold S admits a global parameterization s=s(ξ), optimization can be performed over the parameters ξ, solving \hat{ξ}(x)=arg min_{ξ}− [symbol] s(ξ), x [symbol] using the (Euclidean) gradient method, namely:

$${ξ}^{k + 1} = {ξ}^{k} + {τ}_{k} \cdot {( ∇ s ( {ξ}^{k} ) )}^{T} x , \qquad ( 2 )$$

where ∇s(ξ^{k})∈R^{Dxd} is the Jacobian matrix of s(ξ) at point ξ^{k}.

The estimated signal ŝ(x)=s(\hat{ξ}(x)) and decision statistic î_{TpopT} can be obtained from the estimated parameters \hat{ξ}. The optimization problem is in general nonconvex, and Equations (1) and (2) only converge to global optima when they are initialized sufficiently nearby. Global, optimality can be guaranteed by employing multiple initializations s₁⁰ , . . . , sₙ_{ᵢₙᵢₜ}⁰ which cover the manifold S at some radius Δ where at least one initialization is guaranteed to produce a global optimizer.

As noted, the TpopT approach is computationally efficient in detecting and estimating signals from low-dimensional families. A straightforward application of TpopT requires a precise analytical characterization of the signal manifold. A nonparametric extension of the TpopT approach is provided for scenarios in which only noisy observation data samples, s₁, . . . , s_{N} from S are available.

The approach followed when only a finite number of noisy signal samples, s₁, . . . , s_{N} are available to map these finite number of samples into an embedding space To determine optimized template parameters to apply to the noisy data, a gradient descent procedure could then be applied to the resultant representation of the samples in the embedding space. However, under the proposed approach, the gradient descent optimization is unrolled into a trainable network that produced the required parameters. Thus, under the proposed approach, the optimization problem is re-formulated as a gradient descent (GD) solver. The components of the GD solver a re-formulated so that the GD's components, including the Jacobians, step size, and smoothing levels, all become trainable. Each GD iteration becomes one layer of the machine learning network.

Accordingly, the nonparametric TpopT approach begins by embedding the example points s₁, . . . , s_{N}∈R^{D} into a lower dimensional space R^{d}, producing data points ξ₁, . . . , ξ_{N}∈R^{d}., i.e., sᵢ [symbol] ξᵢ. The mapping (transformation) φ from the observation space to the embedding space can be performed through a number of techniques, including, in the present example, by using principal component analysis (PCA). The inverse mapping of ξ [symbol] s can be obtained through interpolation. Assuming that φ is one-to-one mapping over S, the relationship s=s(ξ) can be used as an approximate parameterization of S, to develop an optimization process which, given an input x, searches for a parameter ξ∈R^{d} that minimizes f(s(ξ))=− [symbol] s(ξ), x [symbol] .

In the non-parametric setting, the values of s(ξ) are known only at the finite point set ξ₁, . . . , ξ_{N}. There is no direct knowledge of the functional form of the mapping s(·) or its derivatives. To extend TpopT to this setting, the Jacobian ∇s(ξ) can be estimated at point ξᵢ by solving a weighted least squares problem, namely:

$$( {ξ}_{i} ) = arg {min}_{J ∈ {ℝ}^{D \times d}} {\sum }_{j = 1}^{N} {w}_{j , i} {‖ {s}_{j} - {s}_{i} - J ( {ξ}_{j} - {ξ}_{i} ) ‖}_{2}^{2} , \qquad ( 3 )$$

where the weights w_{j,i}=Θ(ξᵢ, ξⱼ) are generated by an appropriately chosen kernel Θ. The least squares problem is solvable in closed form. In practice, compactly supported kernels are preferred, so the sum in Equation (3) involves only a small subset of the points ξⱼ. In some examples (e.g., in experiments involving gravitational wave astronomy), the procedure to compute the Jacobians includes an additional quantization step, allowing the computation of approximate Jacobians on a regular grid ξ₁, . . . , ξ_{N} of points in the parameter space Ξ.

In some embodiments, Θ can be chosen to be a truncated radial basis function kernel Θ_{λ},_{δ}(x₁, x₂)=exp(−λ∥x₁−x₂∥₂²)·1_{∥x1-x2∥2<δ}. When example points sᵢ are sufficiently dense and the kernel Θ is sufficiently localized, [symbol] (ξ) will accurately approximate the true Jacobian ∇s(ξ).

In actual applications such as computer vision and astronomy, the signal manifold S often exhibits large curvature κ, leading to a small basin of attraction (the region of a phase space, over which iterations are defined, such that any point in that region will asymptotically be iterated into an attractor, with the attractor being a set of states toward which a system tends to evolve for variety of initial conditions). One approach for increasing the basin size is to smooth the objective function f. Smoothing can be incorporated by taking gradient steps with a kernel smoothed Jacobian, [symbol] (ξᵢ)=Z⁻¹Σⱼw_{j,i} [symbol] (ξⱼ), where w_{j,i}=Θ_{λs, δs}(ξᵢ, ξⱼ), and Z=Σⱼw_{j,i}. The gradient iteration becomes:

$${ξ}^{k + 1} = {ξ}^{k} + {τ}_{k} {( {ξ}^{k} )}^{T} x . \qquad ( 4 )$$

When the Jacobian estimate [symbol] (ξ) approximates ∇s(ξ), this yields:

$${( {ξ}_{i} )}^{τ} x \approx {Z}^{- 1} {\sum }_{j} {w}_{j , i} ∇ {s ( {ξ}_{j} )}^{T} x = ∇ [ {Z}^{- 1} {\sum }_{j} {w}_{j , i} f ( {ξ}_{j} ) ] . \qquad ( 5 )$$

$${T}^{}$$

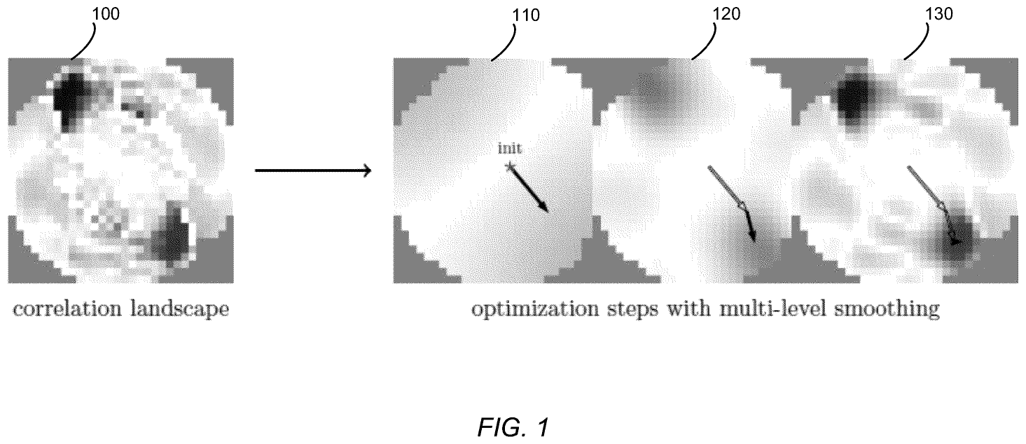

^{T} is an approximate gradient for a smoothed version \tilde{f} of the objective f. FIG. 1 includes diagrams illustrating smoothed optimization landscapes \tilde{f} for different levels of smoothing, i.e., different choices of λₛ. In general, the more smoothing is applied, the broader the basin of attraction. A coarse-to-fine approach can be used, in which in the first iteration commences with a highly smoothed landscape (small λₛ), with the level of smoothing decreasing from iteration to iteration. Thus, in the example of FIG. 1, a correlation landscape 100 is iteratively optimized with multi-level smoothing steps that yield resultant correlations landscapes 110, 120, and 130 as the smoothing level decreases, becoming progressively more detailed from iteration to iteration.

These observations are in line with theory: because the embedding approximately preserves Euclidean distances, ∥ξᵢ−ξⱼ∥₂≈∥sᵢ−sⱼ∥₂, applying kernel smoothing in the parameter space is nearly equivalent to applying kernel smoothing to the signal manifold S, and thus:

$$\tilde{f} ( ξ ) = {Z}^{- 1} {\sum }_{j} Θ ( {ξ}_{i} , {ξ}_{j} ) 〈 {s}_{j} , x 〉 \approx 〈 {Z}^{- 1} {\sum }_{j} Θ ( {s}_{i} , {s}_{j} ) {s}_{j} , x 〉 \qquad ( 6 )$$

This smoothing operation expands the basin of attraction Δ=1/κ, by reducing the manifold curvature κ. Empirically, with appropriate smoothing, a single initialization often suffices for convergence to global optimality, suggesting this as a potential key to breaking the curse of dimensionality.

The non-parametric approach for finding a matching template through an iterative gradient solver requires pre-computing the Jacobians ∇s(ξ) and determining optimization hyperparameters, including the step sizes τₖ and kernel width parameters λₖ at each layer. This approach can be adapted into a trainable architecture, in which the above quantities (e.g., step sizes, kernel width parameters) are learned from data. It is to be noted that the use of a machine learning engine that is trainable using observation data and desired output data defining the ground truths, results in computation of optimized weight values for the machine learning engine that inherently capture characteristics of the low-dimensional signal component that is sought to be recovered by the optimized template produced by the network.

Under the proposed framework, the expression τₖ∇s(ξᵢ)^{T}∈ [symbol] ^{d×D} can be represented as a collection of matrices W(ξᵢ, k), where ξᵢ∈{ξ₁, . . . , ξ_{N}} and k∈{1, . . . , K} where K is the total number of iterations. A gradient descent iteration can thus be written as:

$${ξ}^{. k + 1} = {\sum }_{i = 1}^{N} {w}_{k , i} ( {ξ}_{i} + W ( {ξ}_{i} , k ) x ) , \qquad ( 7 )$$

$$where$$

$${w}_{k , i} = {Θ}_{{λ}_{k} , {d}_{k}} ( {ξ}^{k} , {ξ}_{i} ) .$$

Equation (7) can be interpreted as a kernel interpolated gradient step, where the matrices summarize the Jacobian and step size information. Because Θ is compactly supported, this sum involves only a small subset of the sample points ξᵢ. Unrolling the optimization by viewing each gradient descent iteration (or iteration of some other unrolled optimization technique) as one layer of a trainable machine learning network implementing a computation block to determine a kernel width parameter λₖ, and a computation block implementing the matrices W that summarize the Jacobian and step size information for the particular gradient descent iteration, leads to the implementation of a trainable TpopT architecture.

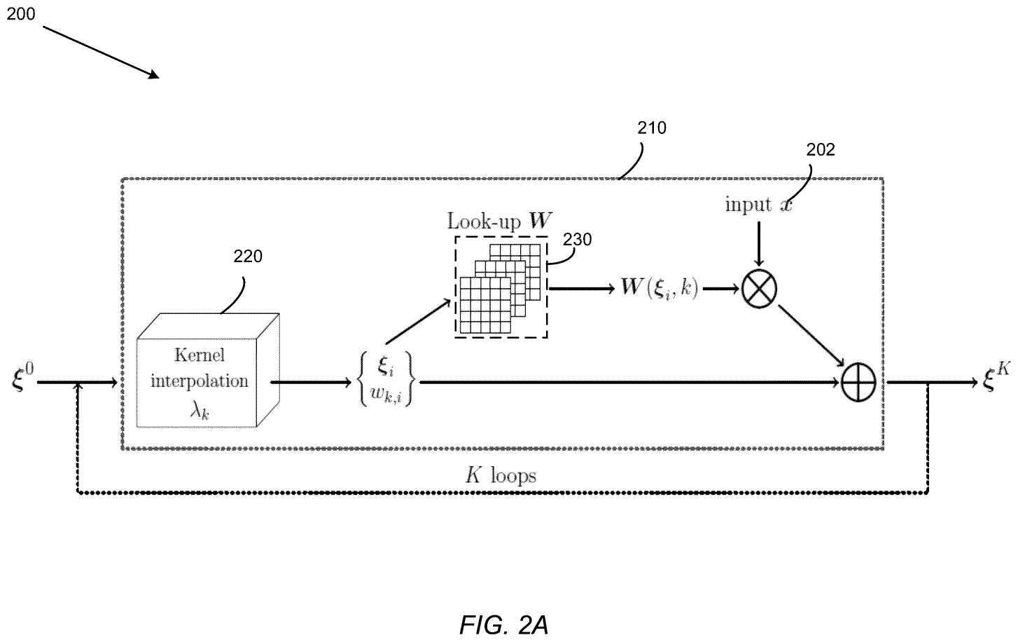

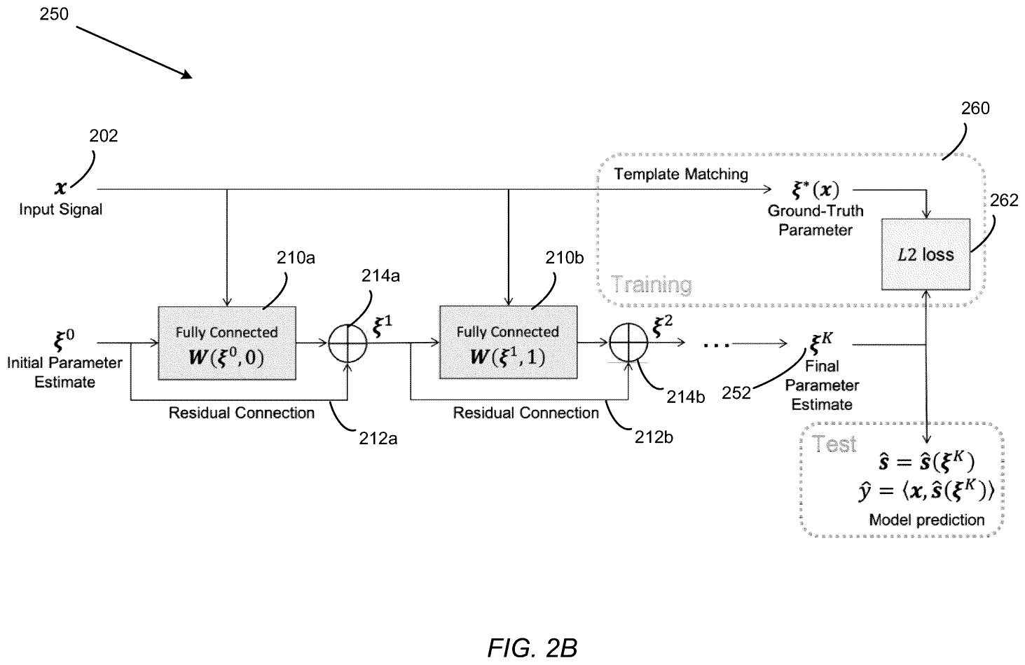

The machine learned optimization process can be implemented by a trainable TpopT architecture such as the one illustrated in FIG. 2A, illustrating an example trainable TpopT framework 200. Particularly, the trainable parameters in the network are the W (ξᵢ, k) matrices and the kernel width parameters λₖ. The architecture 200 includes a dotted box 210 in which a kernel interpolation block 220 and the lookup matrices (W) block 230 are implemented. The dotted box 210 represents one (1) iteration of the gradient descent-based optimization corresponding to one layer of the machine learning network. Thus, if there are K gradient descent iterations that are to be performed for an input data set x, the machine learning system would include at least one machine learning layer corresponding to each of the iterations. The at least one machine learning layer for a particular iteration performs processing matching the processing represented by Equation (7) above to produce, in response to input x and the preceding computed values ξ^{k-1} (computed by a preceding layer of the machine learning system), the output ξ^{k}. That is, the machine learning processing for a particular layer (determined as trained machine learning parameters) produces predicted layer output data that would have (approximately) been produced from brute performance of kernel interpolation and embedding processing (i.e., though numerical calculations) applied to the input to that layer (e.g., preceding values of ξ^{k-1} computed in preceding iteration), to produce the set of values for ξᵢ and w_{k,i}, followed by application of lookup matrices values to ξᵢ and w_{k,i} to produce W(ξᵢ, k). The output of the layer k (corresponding to iteration k of the gradient descent process to determine a template to apply to noisy data) is the set of values ξ^{k+1}, which is then fed to next layer of the machine learning system (corresponding to the next iteration of the gradient descent process) to produce the output of the next iteration. Put another way, each layer of the machine learning system determines through application of the trainable parameters for that layer to the input to that layer, the output that would otherwise need to be performed according to ξ^{k+1}=Σᵢ₌₁^{N}w_{k,i}(ξᵢ+W (ξᵢ, k)x). As noted, for In embodiments in which the gradient descent process includes multiple iterations, multiple dotted boxes such as the box 210, each implementing kernel interpolation, embedding and matrix multiplications by way of machine learning nodes and weights, would be deployed.

As shown in FIG. 2A, for the very first iteration, the machine learning system takes x as the input data and starts with a fixed initialization ξ⁰. The application of K machine learning layers corresponding to the K iterations of the gradient descent process results in convergence of the initial values for ξ⁰ to the desired output values of ξ^{K} produced by the last layer of the machine learning implementation for computing optimized template filter parameters.

Derivation of values for the trainable parameters of the machine learning system (to determine an optimized template to filter out noise in high dimensional spaces) may be performed according to different optimization techniques. For example, in some embodiments, the optimization techniques may be based on minimization of a [symbol] loss function for signal estimation according to:

$$ℒ = \frac{1}{{N}_{train}} {\sum }_{j = 1}^{{N}_{train}} {‖ {ξ}^{k} ( {x}_{j} ) - {ξ}^{*} ( {x}_{j} ) ‖}_{2}^{2} . \qquad ( 8 )$$

The above loss/error function can be used for training the machine learning system 200 (or the system 250 discussed below) with a training set {xⱼ}ⱼ₌₁^{N}^{ₜᵣₐᵢₙ} that uses, for example, positive j=1 data only. The above loss function is generally well-aligned with the signal estimation tasks, and is also applicable to detection.

With reference next to FIG. 2B, a block diagram is provided of an example system 250 with an architecture that may be similar to the architecture used by the system 200 of FIG. 2A. FIG. 2B provides further details about the machine learning architecture used to derive a noise filtering template. As shown in FIG. 2B, the system 250 includes blocks 210a and 210b which may be layers of a machine learning system to derive the optimized template. Each of the blocks 210a and 210b may be similar to the block 210 depicted in FIG. 2A. As such, each of the blocks can comprise an arrangement of trainable neural network nodes (not shown) that, in some embodiments, can be fully connected to trainable nodes of the preceding layer (if there is a preceding layer) and to the subsequent layer. Thus, for example, the nodes of the block 210amay be fully connected to nodes of the block 210b that is used to implement the subsequent layer (representing the next iteration of a gradient descent process) of the machine learning system 250. The connections between nodes are adjustable weights that are applied to inputs/outputs of the nodes in each layer. The training process for the system 250 derives the weight values that govern the desired behavior of the system so that the system 250 produces a final output (e.g., output 252, corresponding to the final parameter estimate for ξ^{K}) that is consistent with the training data processed by the training module 260 of the system 250. The nodes in the various layers comprising the machine learning system 250 may themselves also be adjustably configured to provide another set of parameters that can be optimized to produced desired outputs.

The first block 210a (corresponding to the first layer of the machine learning system, and to the first iteration of the gradient descent process) receives as input an initial parameter estimate ξ⁰ and the input signal x (with values comprising noisy observed samples from some physical system that is to be analyzed). In response to those inputs, the first block produces the first iteration matrix W(ξ⁰, 0). As noted, the first layer is trained to determine parameters (e.g., weights of node connections) that yield estimated values, W(ξ⁰, 0), that would have been computed through brute matrix calculations. The determined estimated values for W(ξ⁰, 0) are combined (via the residual connection 212a and the summation operation 214a) with the initial parameter estimate ξ⁰ (in accordance with Equation (7)) to produce the first iteration output parameters ξ¹.

With continued reference to FIG. 2B, the first iteration output parameters ξ¹ are next provided to the second layer (corresponding to the second gradient descent iteration) of the machine learning system 250, along with the input value x, to produce, according to the previously computed machine learning trainable parameters of the second layer, the estimated values for W(ξ¹, 1). Here too, the output parameter values ξ¹ of the preceding layer (implemented by block 210a) are combined (via the residual connection 212b and the summation operation 214b) with W(ξ¹, 1). To produce the second layer's estimated output parameter values ξ¹ that is then used to compute the next iteration of the parameter values for the gradient descent procedure. This iterative process continues for K iteration (with K≥1) to produce the final parameter estimate ξ^{K} for the optimized template to be applied to noisy observation data of a high-dimensional system.

As further illustrated in FIG. 2B, in various embodiments the system 250 may also include a training module 260 to train the system 250 to produce desirable output responsive to the particular input provided. The training module determines parameter values for the parameters defining the various machine learning layers of the system 250 by adjusting (e.g., iteratively adjusting or adapting) the machine learning parameters during a training stage executed prior to the system becoming operational. The machine learning parameters are adjusted to minimize an error metric function (e.g., L2 loss function, such as the function provided in Equation (8), implemented using an L2 loss block 262) between output predicted (estimated) by the machine learning layers of the system 250, and independently computed desired output (represented as ξ*(x)) defining the ground truth. The minimization process may be based on various techniques such as a using a stochastic gradient descent procedure to minimize the loss metric. In FIG. 2B, input training data (e.g., x_{training} is provided to the layers being trained (optimized) to produce an estimated template parameter set ξ^{K}. That same input training data may be provided to the training module 260 which includes optimal templates that may have independently been identified for the training data x_{training}) through a template matching procedure. An error function is then applied to the estimated template parameter set ξ^{K} and the ground truth template parameters ξ*(x). Employing an optimization process (e.g., an Adaptive Moment Estimation, or ADAM, optimizer) that uses the error computed through the error function, the machine learning parameters that are used in the implementation of the machine learning layers (e.g., layers 210a, 210b, . . . , 210K) are updated. Alternatively, in another example, instead of computing ground truth template parameters ξ*(x), the training data x_{training}may be provided along with previously determined optimal ground truth template parameters ξ*(x). Such data (the training data and its corresponding optimal ground truth output data) may be available from various data repositories that collect previously observed data. Other ways and techniques for training the machine learning implementation for deriving filter template parameters may be used.

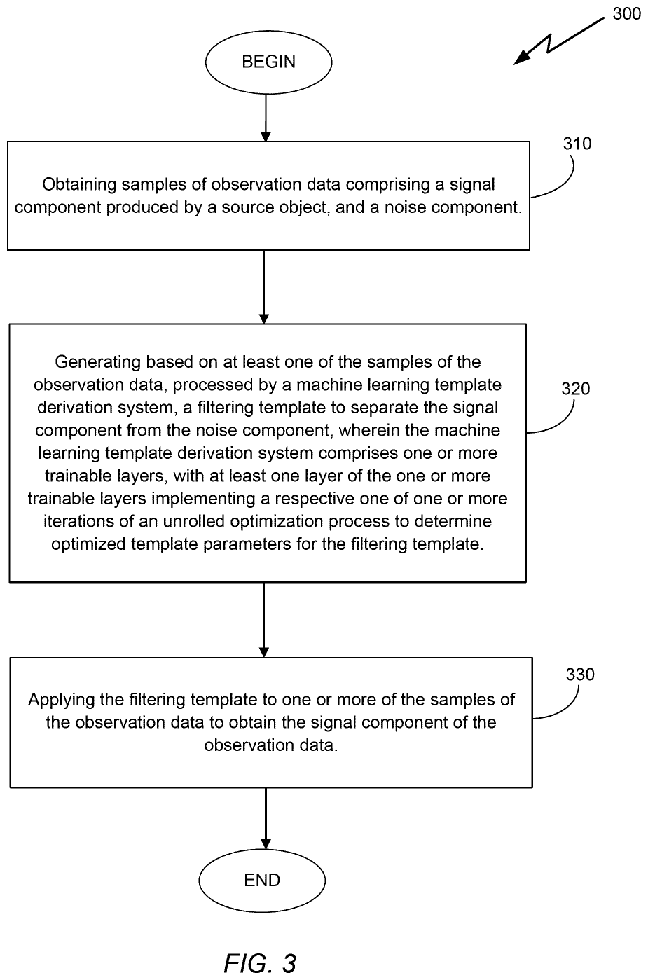

With reference next to FIG. 3, a flowchart of a procedure 300 for signal detection using an optimized noise filtering template applied to high-dimensional data (e.g., D>100, 1000, 10,000 or any other high number of dimensions) is shown. The procedure 300 includes obtaining 310 samples of observation data comprising a signal component produced by a source object, and a noise component. In some embodiments, the observation data may be representative of signals measured in a high-dimensional signal space, with the signal component produced by the source object occupying a low-dimensional submanifold of the high-dimensional signal space. However, the optimized template produced by the techniques and implementations described herein may also be used for low-dimensional observation data (as in the case of the handwritten digit recognition experiment described below). In various examples, the samples of observation data may include samples of gravitationally-produced observation data that include gravitational waves data component.

Continuing with FIG. 3, the procedure 300 further includes generating 320 based on at least one of the samples of the observation data, processed by a machine learning template derivation system, a filtering template to separate the signal component from the noise component, with the machine learning template derivation system including one or more trainable layers, and with at least one layer of the one or more trainable layers implementing a respective one of one or more iterations of an unrolled optimization process to determine optimized template parameters for the filtering template.

In various examples, the unrolled optimization process may include a gradient descent optimization process. In such examples, generating the filtering template can include determining, in response to the at least one of the samples of the observation data, layer output parameters representing a resultant respective Jacobian matrix and step size information for the respective one of the one or more iterations of the gradient descent optimization process implemented by the one or more layers of the machine learning template derivation system. The resultant respective Jacobian matrix and step size for the respective one of the one or more iterations of the gradient descent optimization process may be represented by a collection of resultant layer output lookup matrices, W.

In some embodiments, determining the layer output parameters may include applying the trained parameter values of the at least one layer of the machine learning template derivation system to the at least one of the samples of the observation data, and further to a previously determined set of values of the template parameters, ξ^{k-1}, to generate the layer output parameters representing the resultant respective Jacobian matrix and the step size information for the respective one of the one or more iterations of the gradient descent optimization process. In such embodiments, the procedure 300 may further include combining the layer output parameters with the previously determined set of values of the template parameters to produce a next set of values of the template parameters, ξ^{k}. In some examples, the next set of values of the template parameters, ξ^{k}, may be produced by a last layer of the machine learning, with ξ^{k} representing the final template parameters for the filtering template. In some examples, the next set of values of template parameters, ξ^{k}, may be produced by a first layer of the machine learning template derivation system, with the previously determined set of values of the template parameters, ξ^{k-1} representing an initial estimate, ξ⁰, of the template parameters for the filtering template.

In some embodiments, the procedure 300 may further include providing the next set of values of template parameters, ξ^{k}, and the at least one of the samples of the observation data to a next at least one layer of the one or more layers of the machine learning template derivation system to determine a next set of values of the template parameters, ξ^{k+1}.

With continued reference to FIG. 3, the procedure 300 additionally includes applying 330 the filtering template to one or more of the samples of the observation data to obtain the signal component of the observation data. (e.g., to remove the noisy component)

In some embodiments, the machine learning template derivation system may include a neural-network-based machine learning template derivation system. In some embodiments, the procedure 300 may further include training, prior to obtaining the samples of observation data, the one or more layers of the machine learning template derivation system with training data, the training data comprising input data representing observation samples, and output data representing ground truth data associated with the input data, with the ground truth data including one or more of, for example, template parameters computed in response to the training data using a matched filtering technique and/or previously determined template parameters that were used for the input data.

To test and evaluate the performance of the proposed trainable TpopT framework, several studies/experiments were conducted. In a first experiment, a trainable TpopT framework was developed and applied to gravitational data to facilitate gravitational wave detection. The use of the TpopT framework demonstrated a significant improvement in efficiency-accuracy tradeoffs over the conventional matched filtering (MF) techniques. A second experiment was conducted to apply a trainable TpopT framework to low dimensional data involving handwritten digit data, and here too the TpopT framework outperformed traditional noise filtering methodologies such as MF. To compare the efficiency-accuracy tradeoffs of MF and TpopT models, it is noted that for MF, the computation cost of the statistic max_{i=1, . . . , n} [symbol] sᵢ, x [symbol] is dominated by the cost of n length D inner products, requiring nD multiplication operations. On the other hand, running the TpopT framework, with M parallel initializations, K iterations of the gradient descent, m neighbors in the truncated kernel, and a final evaluation of the statistic, requires MD (Kdm+1) multiplications; other operations including the kernel interpolation and look-up of pre-computed gradients have negligible test-time cost.

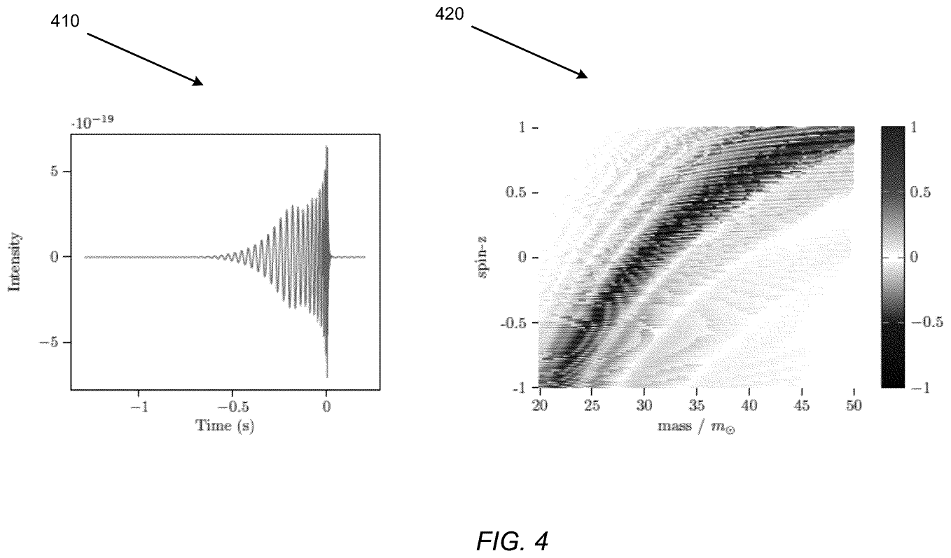

In the first experiment, for gravitational wave detection, the aim was to detect a family of gravitational wave signals from Gaussian noise. Each gravitational wave signal is a one-dimensional chirp-like signal, as illustrated in graph 410 of FIG. 4. The raw data of gravitational wave detection is a noisy one-dimensional time series, where gravitational wave signals can occur at arbitrary locations. The problem was simplified by considering input segments of fixed time durations.

Based on their physical modeling, gravitational wave signals are equipped with a set of physical parameters, such as the masses and three-dimensional spins of the binary black holes that generate them, etc. While it is tempting to directly optimize on this native parameter space, unfortunately the optimization landscape on this space turns out to be unfavorable, as shown in graph 420 of FIG. 4. It can be seen from the graph 420 of FIG. 4 that the objective function has many spurious local optimizers and is poorly conditioned. However, signal embedding can be used to create an alternative set of approximate “parameters” that are better suited for optimization.

Synthetic gravitational waveforms were generated with the PyCBC package with masses uniformly drawn from [20, 50] (times solar massM⊙) and 3-dimensional spins drawn from a uniform distribution over the unit ball, at sampling rate 2048 Hz. Each waveform was padded or truncated to 1 second long such that the peak was aligned at the 0.9 second location, and then normalized to have unit [symbol] norm. Noise was simulated as iid Gaussian with standard deviation σ=0.1. The signal amplitude was constant with a=1. The training set contained 100,000 noisy waveforms, and the test set contained 10,000 noisy waveforms and pure noise each, and a separate validation set constructed iid as the test set is used to select optimal template banks for MF.

For the signal embedding, PCA with dimension 2 was applied on a separate set of 30,000 noiseless waveforms drawn from the same distribution. Because the embedding dimension is relatively low, the embedding parameter space was quantized with an evenly-spaced grid, with the range of each dimension evenly divided into 30 intervals.

The value ξ⁰ at the initial layer of TpopT was fixed at the center of this quantization grid. Prior to training, the optimization hyperparameters (step sizes and smoothing levels) were first determined using a layer-wise greedy grid search, where the step size and smoothing level at each layer were sequentially chosen as if it were the final layer. This greedy approach significantly reduced the cost of the search. From there, these optimization hyperparameters were used to initialize the trainable TpopT network, and train the parameters on the training set. The Adam optimizer was used with batch size 100 and constant learning rate 10⁻². Regarding the computational cost of TpopT, the following parameter values were used: M=1 (M being the number of parallel initialization), d=2, m=4 during training (m being the number of neighbors in the truncated kernel), and m=1 during testing. Since the complexity is measured at test time, the complexity with K-layer TpopT is D(2K+1).

To evaluate the performance of matched filtering with n filters and complexity nD, 1,000 independent sets of n templates, drawn from the above distribution, were randomly generated. The ROC curves of each set of templates were evaluated on the validation set, and the set with the highest area-undercurve (AUC) score was selected. This selected template bank was then compared with TpopT on the shared test set.

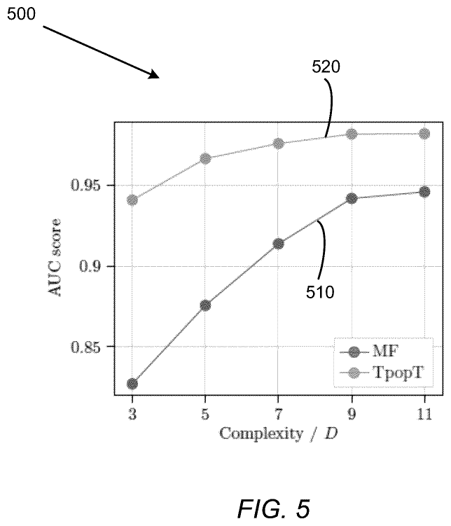

FIG. 5 includes a graph 500 of the classification scores of MF (curve 510) and TpopT (curve 520) at different complexity levels, for gravitational wave detection. FIG. 5 shows a comparison of efficiency-accuracy tradeoffs for this task between matched filtering and TpopT after training. It can be seen that TpopT achieves significantly higher detection accuracy compared with MF at equal complexity.

Turning next to the second experiment that was conducted to test the performance of the TpopT framework, here the aim was to demonstrate the wide applicability of the TpopT framework also to datasets that exhibit low-dimensional manifold structures. In particular, the second experiment focused on the task of detecting handwritten digits ‘3’ from other digits based on the MNIST dataset, with random Euclidean transformations applied to each image. This can be approximately fit under the data model discussed herein where the set of transformed digits ‘3’ is modeled as the signal manifold S, and other digits are modeled as noise.

The MNIST training set contains 6,131 images of the digit ‘3’. In particular, a training set containing 10,000 images of randomly transformed digit 3 from the MNIST training set, and a test set containing 10,000 images each of randomly transformed digit 3 and other digits from the MNIST test set were created. The transformation applied had translation uniformly distributed between ±0.1 image size on each dimension, and rotation angle uniformly distributed between ±30°.

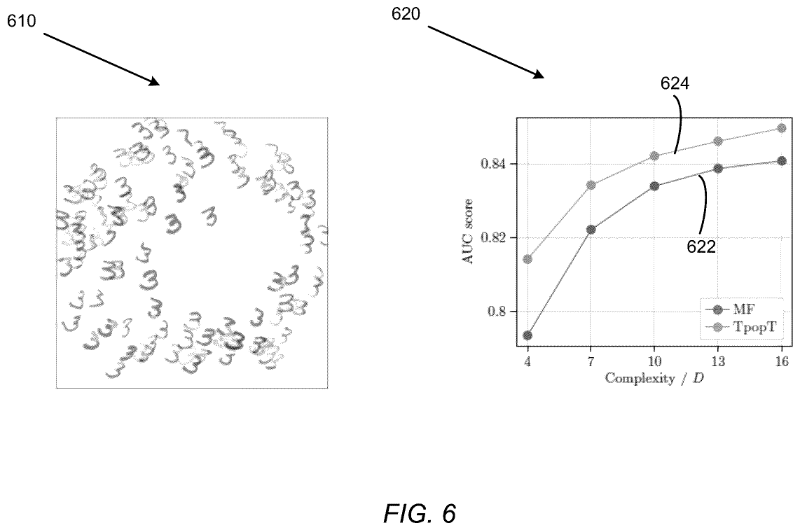

Since the signal space is nonparametric, a 3-dimensional PCA embedding was first created from the training set. FIG. 6 includes a graph 610 showing a slice of the 3-D embedding projected onto the first two embedding dimensions. A random subset of 1,000 embedded points was first selected as the quantization \hat{ }Ξ of the parameter space, and a k-d tree was constructed from it to perform efficient nearest neighbor search for kernel interpolation. Parameters of the trainable TpopT are initialized using heuristics based on the Jacobians, step sizes and smoothing levels from the unrolled optimization. ξ⁰ is initialized at the center of the embedding space. The Adam optimizer was used with batch size 100 and constant learning rate 10⁻³. Regarding the computational cost of TpopT, the following parameter values were used: M=1, d=3, m=5during training and m=1 during testing. The complexity with K-layer TpopT was D(3K+1).

Matched filtering was also evaluated similarly to the way it was evaluated in the first experiment. A random subset of 500 images of digit 3 from the MNIST training set is first selected, and the validation set was constructed from it. The remaining images were used to randomly generate 1,000 independent sets of transformed digits ‘3’, and the best-performing set of templates on the validation set was selected as the MF template bank, and compared with TpopT on the shared test set. Graph 620 of FIG. 6 shows the comparison of efficiency-accuracy tradeoffs between the two methods. The comparison of the MF method (curve 622) to the TpopT method (curve 624) shows a consistently higher detection accuracy of trained TpopT over MF at equal complexities.

Thus, as described herein, the TpopT framework provides an approach for efficient detection of low-dimensional signals, with TpopT having superior dimension scaling compared to MF. Embodiments of the TpopT framework include a trainable TpopT architecture that can handle general nonparametric families of signals. Experimental results showed that trained TpopT achieves significantly improved efficiency-accuracy tradeoffs than MF, for example, in the gravitational wave detection task (where MF is the current method of choice). It is noted that non-parametric TpopT implementation require high storage capacity since the framework uses a dense collection of points and Jacobians, with cost exponential in intrinsic dimension d. Nevertheless, both TpopT and its nonparametric extension achieve exponential improvements in test-time efficiency compared to MF. In experiments, the proposed smoothing feature of the framework allowed convergence to global optimality from a single initialization.

Performing the various techniques and operations described herein may be facilitated by a controller device(s) (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, signal detection using an optimized template determined with a trainable machine learning system. The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

In implementations based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“ neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc. Further examples of learning architectures that may be used to implement the framework described herein include language models architectures, large language model (LLM) learning architectures, auto-regressive learning approaches, etc. In some embodiments, encoder-only architectures, decoder-only architectures, encoder-decoder architecture may also be used in implementations of the framework described herein.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuity, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the neural networks described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, PyTorch, JAX, and other machine learning frameworks.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus, and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for signal detection, the method comprising:
obtaining samples of observation data comprising a signal component produced by a source object, and a noise component;
generating based on at least one of the samples of the observation data, processed by a machine learning template derivation system, a filtering template to separate the signal component from the noise component, wherein the machine learning template derivation system comprises one or more trainable layers, with at least one layer of the one or more trainable layers implementing a respective one of one or more iterations of an unrolled optimization process to determine optimized template parameters for the filtering template; and
applying the filtering template to one or more of the samples of the observation data to obtain the signal component of the observation data.

2. The method of claim 1, wherein the observation data is representative of signals measured in a high-dimensional signal space, and wherein the signal component produced by the source object occupies a low-dimensional submanifold of the high-dimensional signal space.

3. The method of claim 1, wherein the unrolled optimization process comprises a gradient descent optimization process.

4. The method of claim 3, wherein generating the filtering template comprises:
determining, in response to the at least one of the samples of the observation data, layer output parameters representing a resultant respective Jacobian matrix and step size information for a respective one of the one or more iterations of the gradient descent optimization process implemented by the one or more layers of the machine learning template derivation system.

5. The method of claim 4, wherein the resultant respective Jacobian matrix and step size for the respective one of the one or more iterations of the gradient descent optimization process are represented by a collection of resultant layer output lookup matrices, W.

6. The method of claim 4, wherein determining the layer output parameters comprises:
applying the trained parameter values of the at least one layer of the machine learning template derivation system to the at least one of the samples of the observation data, and further to a previously determined set of values of the template parameters, ξ^{k-1}, to generate the layer output parameters representing the resultant respective Jacobian matrix and the step size information for the respective one of the one or more iterations of the gradient descent optimization process.

7. The method of claim 6, further comprising:
combining the layer output parameters with the previously determined set of values of the template parameters to produce a next set of values of template parameters, ξ^{k}.

8. The method of claim 7, wherein the next set of values of the template parameters, ξ^{k}, is produced by a last layer of the machine learning, with ξ^{k} representing the final template parameters for the filtering template.

9. The method of claim 7, wherein the next set of values of template parameters, ξ^{k} , is produced by a first layer of the machine learning template derivation system, with the previously determined set of values of the template parameters, ξ^{k-1} representing an initial estimate, ξ⁰, of the template parameters for the filtering template.

10. The method of claim 7, further comprising:
providing the next set of values of template parameters, ξ^{k}, and the at least one of the samples of the observation data to a next at least one layer of the one or more layers of the machine learning template derivation system to determine a further next set of values of template parameters, ξ^{k+1}.

11. The method of claim 1, wherein the samples of observation data comprise samples of gravitationally-produced observation data comprising a gravitational waves data component.

12. The method of claim 1, wherein the machine learning template derivation system comprises a neural-network-based machine learning template derivation system.

13. The method of claim 1, further comprising:
training, prior to obtaining the samples of observation data, the one or more layers of the machine learning template derivation system with training data, the training data comprising input data representing observation samples, and output data representing ground truth data associated with the input data, wherein the ground truth data includes one or more of: template parameters computed in response to the training data using a matched filtering technique, or previously determined template parameters that were used for the input data.

14. A signal detection system comprising:
one or more memory storage devices; and
a processor-based device in electrical communication with the one or more memory storage devices, the processor-based device configured to:
obtain samples of observation data comprising a signal component produced by a source object, and a noise component;
generate based on at least one of the samples of the observation data, processed by a machine learning template derivation system, a filtering template to separate the signal component from the noise component, wherein the machine learning template derivation system comprises one or more trainable layers, with at least one layer of the one or more trainable layers implementing a respective one of one or more iterations of an unrolled optimization process to determine optimized template parameters for the filtering template; and
apply the filtering template to one or more of the samples of the observation data to obtain the signal component of the observation data.

15. The system of claim 14, wherein the unrolled optimization process comprises a gradient descent optimization process.

16. The system of claim 15, wherein the processor-based device configured to generate the filtering template is configured to:
determine, in response to the at least one of the samples of the observation data, layer output parameters representing a resultant respective Jacobian matrix and step size information for a respective one of the one or more iterations of the gradient descent optimization process implemented by the one or more layers of the machine learning template derivation system.

17. The system of claim 15, wherein the processor-based device configured to determine the layer output parameters is configured to:
apply the trained parameter values of the at least one layer of the machine learning template derivation system to the at least one of the samples of the observation data, and further to a previously determined set of values of the template parameters, ξ^{k-1}, to generate the layer output parameters representing the resultant respective Jacobian matrix and the step size information for the respective one of the one or more iterations of the gradient descent optimization process.

18. The system of claim 17, wherein the processor-based device is further configured to:
combine the layer output parameters with the previously determined set of values of the template parameters to produce a next set of values of template parameters, ξ^{k}.

19. The system of claim 18, wherein the processor-based device is further configured to:
provide the next set of values of template parameters, ξ^{k}, and the at least one of the samples of the observation data to a next at least one layer of the one or more layers of the machine learning template derivation system to determine a further next set of values of template parameters, ξ^{k+1}.

20. Non-transitory computer readable media comprising computer instructions executable on a processor-based device to:
obtain samples of observation data comprising a signal component produced by a source object, and a noise component;
generate based on at least one of the samples of the observation data, processed by a machine learning template derivation system, a filtering template to separate the signal component from the noise component, wherein the machine learning template derivation system comprises one or more trainable layers, with at least one layer of the one or more trainable layers implementing a respective one of one or more iterations of an unrolled optimization process to determine optimized template parameters for the filtering template; and
apply the filtering template to one or more of the samples of the observation data to obtain the signal component of the observation data.
